(19) United States
(12) Patent Application Publication
(10) Pub. No.: US 2025/0371455 A1
(43) Pub. Date: Dec. 4, 2025

(54) TECHNOLOGIES FOR OPTIMIZING SLOT ALLOCATIONS FOR WORK PLAN ASSIGNMENTS IN CONTACT CENTERS

(71) Applicant: Genesys Cloud Services, Inc., Menlo Park, CA (US)

(72) Inventors: William D'Attilio, Menlo Park, CA (US); Wei Xun Ter, Menlo Park, CA (US); Bayu Wicaksono, Menlo Park, CA (US); German Andres Velasquez Diaz, Menlo Park, CA (US); Temitayo Bankole, Menlo Park, CA (US); Brad Rothnie, Menlo Park, CA (US)

(21) Appl. No.: 18/680,582

(22) Filed: May 31, 2024

(51) Int. Cl. G06Q 10/0631

(52) U.S. Cl. CPC G06Q 10/063112; G06Q 10/063116

(57) ABSTRACT

A method of optimizing slot allocations for agent work plan assignments in contact centers according to an embodiment includes generating, by a computing system, a predetermined number of work plan patterns, solving, by the computing system, a pattern selection model based on the generated work plan patterns to determine a type and number of work plan patterns to be used for each agent bid group of a plurality of agent bid groups, wherein the pattern selection model includes a plurality of constraints and at least one objective function, and allocating, by the computing system, agent work plan slots based on the solved pattern selection model by defining a number of agents that can be assigned to each work plan pattern of the plurality of work plan patterns.

### BACKGROUND

Contact centers often rely on a very large number of agents to communicate with and respond to client inquiries. Although contact center costs may come from different sources, the most important costs in a contact center are typically associated with staffing. Therefore, contact centers attempt to schedule the right number of employees with the right skills at the right time to handle the interaction workload and meet the relevant quality standards. Traditional scheduling technologies are insufficient to handle the complexities and scale of modern contact centers. Additionally, contact centers have notoriously high turnover of agents, which is improved by giving agents input into their schedules, but this added layer of complexity makes already-complex scheduling technologies even more complex.

### SUMMARY

Various embodiments are directed to one or more unique systems, components, and methods for optimizing slot allocations for work plan assignments in contact centers. Other embodiments are directed to apparatuses, systems, devices, hardware, methods, and combinations thereof for optimizing slot allocations for work plan assignments in contact centers.

According to an embodiment, a method of optimizing slot allocations for agent work plan assignments in contact centers may include generating, by a computing system, a predetermined number of work plan patterns, solving, by the computing system, a pattern selection model based on the generated work plan patterns to determine a type and number of work plan patterns to be used for each agent bid group of a plurality of agent bid groups, wherein the pattern selection model includes a plurality of constraints and at least one objective function, and wherein each agent bid group of the plurality of agent bid groups defines a distinct group of agents, and allocating, by the computing system, agent work plan slots based on the solved pattern selection model by defining a number of agents that can be assigned to each work plan pattern of the plurality of work plan patterns.

In some embodiments, the at least one objective function may be based on an understaffing parameter and an overstaffing parameter.

In some embodiments, the plurality of constraints may include a constraint that all agent bid group available time must be assigned to planning groups.

In some embodiments, the plurality of constraints may include a constraint that a number of slots assigned to the work plan patterns in a particular agent bid group is equal to a number of agents in the particular agent bid group.

In some embodiments, the pattern selection model may include as inputs at least one of capabilities of the agents, a number of slots to be assigned for each agent bid group of the plurality of agent bid groups, work plan patterns for each agent bid group of the plurality of agent bid groups, or a workload for each planning group.

In some embodiments, determining the agent work plan slots may include executing a greedy heuristic to solve for each agent bid group of the plurality of agent bid groups.

In some embodiments, the method may further include pre-processing, by the computing system, non-biddable agents, and generating the predetermined number of work plan patterns may include generating the predetermined number of work plan patterns subsequent to pre-processing the non-biddable agents.

In some embodiments, generating the predetermined number of work plan patterns may include generating a plurality of day patterns, wherein each day pattern of the plurality of day patterns is indicative of a unique set of working days and days off for a week.

In some embodiments, generating the predetermined number of work plan patterns may include generating a plurality of shift identifier (ID) patterns based on the plurality of day patterns, wherein each shift ID pattern of the plurality of shift ID patterns is indicative of a shift ID for each working day in a week.

In some embodiments, generating the predetermined number of work plan patterns may include generating a plurality of shift start patterns based on the plurality of shift ID patterns, wherein each shift start pattern of the plurality of shift start patterns is indicative of a shift start time and a shift end time for each shift ID in the work plan.

In some embodiments, generating the predetermined number of work plan patterns may include generating a plurality of work plan patterns based on the plurality of shift start patterns, wherein each work plan pattern of the plurality of work plan patterns is indicative of a shift start pattern assigned to each day of the week.

In some embodiments, generating the predetermined number of work plan patterns may include utilizing a first tiered list data structure for storing data associated with the plurality of day patterns, a second tiered list data structure for storing data associated with the plurality of shift ID patterns, and a third tiered list data structure for storing data associated with the plurality of shift start patterns.

In some embodiments, the method may further include determining, by the computing system, forecast data representative of a typical week at a contact center, and generating the predetermined number of work plan patterns may include generating the predetermined number of work plan patterns based on the forecast data.

In some embodiments, solving the pattern selection model based on the generated work plan patterns may include solving a linear program.

According to another embodiment, a computing system for optimizing slot allocations for agent work plan assignments in contact centers may include at least one processor and at least one memory comprising a plurality of instructions stored thereon that, in response to execution by the at least one processor, causes the computing system to generate a predetermined number of work plan patterns, solve a pattern selection model based on the generated work plan patterns to determine a type and number of work plan patterns to be used for each agent bid group of a plurality of agent bid groups, wherein the pattern selection model includes a plurality of constraints and at least one objective function, and wherein each agent bid group of the plurality of agent bid groups defines a distinct group of agents, and allocate work plan slots based on the solved pattern selection model by defining a number of agents that can be assigned to each work plan pattern of the plurality of work plan patterns.

In some embodiments, to generate the predetermined number of work plan patterns may include to generate a plurality of day patterns, wherein each day pattern of the plurality of day patterns is indicative of a unique set of working days and days off for a week.

In some embodiments, to generate the predetermined number of work plan patterns may include to generate a plurality of shift identifier (ID) patterns based on the plurality of day patterns, wherein each shift ID pattern of the plurality of shift ID patterns is indicative of a shift ID for each working day in a week.

In some embodiments, to generate the predetermined number of work plan patterns may include to generate a plurality of shift start patterns based on the plurality of shift ID patterns, wherein each shift start pattern of the plurality of shift start patterns is indicative of a shift start time and a shift end time for each shift ID in the work plan.

In some embodiments, to generate the predetermined number of work plan patterns may include to generate a plurality of work plan patterns based on the plurality of shift start patterns, wherein each work plan pattern of the plurality of work plan patterns is indicative of a shift start pattern assigned to each day of the week.

In some embodiments, to generate the predetermined number of work plan patterns may include to utilize a first tiered list data structure for storing data associated with the plurality of day patterns, a second tiered list data structure for storing data associated with the plurality of shift ID patterns, and a third tiered list data structure for storing data associated with the plurality of shift start patterns.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 depicts a simplified block diagram of at least one embodiment of a contact center system;

FIG. 2 is a simplified block diagram of at least one embodiment of a computing device;

FIG. 3 illustrates an example graphical user interface for displaying a work plan configuration;

FIG. 4 is a simplified flow diagram of at least one embodiment of a finite state machine for a work plan bid/request process;

FIG. 5 is a simplified flow diagram of at least one embodiment of a method for determining work plan assignments;

FIG. 6 is a simplified flow diagram of at least one embodiment of a method for optimizing slot allocations for work plan assignments in contact centers;

FIG. 7 illustrates an example graphical user interface for displaying a bid overview;

FIG. 8 illustrates an example graphical user interface for configuring bid settings;

FIG. 9 illustrates an example graphical user interface for forecast data selection;

FIGS. 10-14 illustrate example graphical user interfaces for determining bid groups;

FIG. 15 illustrates an example graphical user interface for starting a slot optimization process;

FIG. 16 illustrates an example graphical user interface for displaying results of the slot optimization process;

FIG. 17 illustrates an example graphical user interface for agent work plan ranking;

FIG. 18 illustrates an example graphical user interface for displaying agent submissions from the work plan ranking;

FIGS. 19-20 illustrate example graphical user interfaces for allowing an administrator to override an agent work plan assignment;

FIG. 21 illustrates example abbreviations, notations, and/or sets to be used in conjunction with a pattern selection model;

FIG. 22 illustrates example decision variables to be used in conjunction with a pattern selection model;

FIG. 23 illustrates example constraints to be used in conjunction with a pattern selection model;

FIG. 24 is a simplified example of pseudocode for converting an array of floating variables in a pattern selection model output to an integer solution;

FIGS. 25-26 illustrate a table of shift constraints that are configurable in a work plan and their definitions;

FIG. 27 illustrates a table of slot allocation benchmarks for various types of work plans; and

FIG. 28 illustrates a table of the benchmark results for each of the slot allocation benchmarks of FIG. 27.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

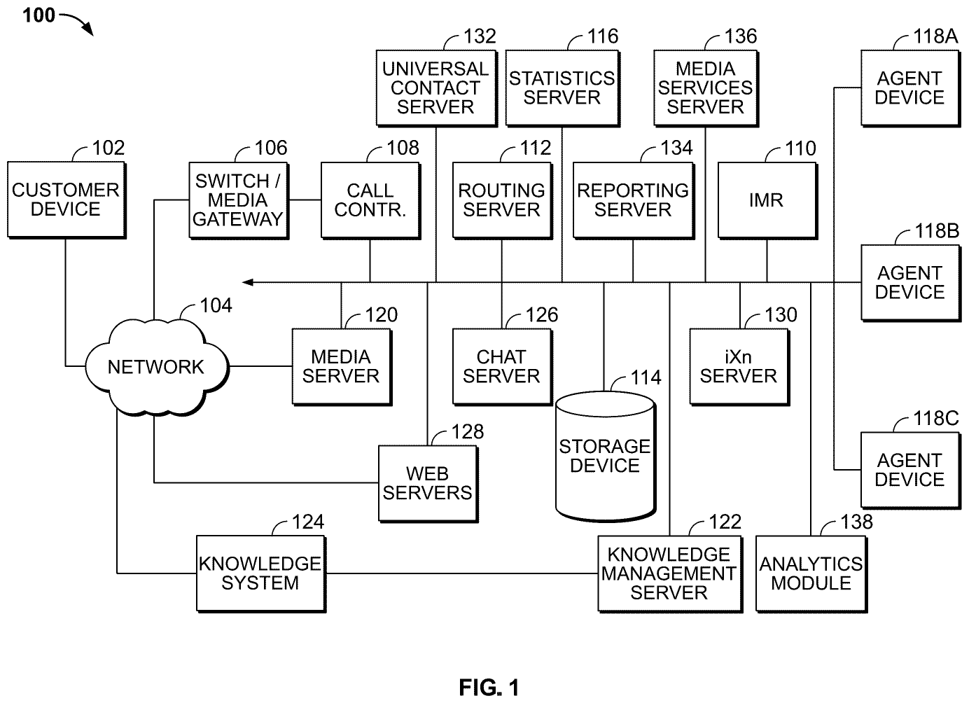

Referring now to FIG. 1, a simplified block diagram of at least one embodiment of a communications infrastructure and/or content center system, which may be used in conjunction with one or more of the embodiments described herein, is shown. The contact center system 100 may be embodied as any system capable of providing contact center services (e.g., call center services, chat center services, SMS center services, etc.) to an end user and otherwise performing the functions described herein. The illustrative contact center system 100 includes a customer device 102, a network 104, a switch/media gateway 106, a call controller 108, an interactive media response (IMR) server 110, a routing server 112, a storage device 114, a statistics server 116, agent devices 118A, 118B, 118C, a media server 120, a knowledge management server 122, a knowledge system 124, chat server 126, web servers 128, an interaction (iXn) server 130, a universal contact server 132, a reporting server 134, a media services server 136, and an analytics module 138. Although only one customer device 102, one network 104, one switch/media gateway 106, one call controller 108, one IMR server 110, one routing server 112, one storage device 114, one statistics server 116, one media server 120, one knowledge management server 122, one knowledge system 124, one chat server 126, one iXn server 130, one universal contact server 132, one reporting server 134, one media services server 136, and one analytics module 138 are shown in the illustrative embodiment of FIG. 1, the contact center system 100 may include multiple customer devices 102, networks 104, switch/media gateways 106, call controllers 108, IMR servers 110, routing servers 112, storage devices 114, statistics servers 116, media servers 120, knowledge management servers 122, knowledge systems 124, chat servers 126, iXn servers 130, universal contact servers 132, reporting servers 134, media services servers 136, and/or analytics modules 138 in other embodiments. Further, in some embodiments, one or more of the components described herein may be excluded from the system 100, one or more of the components described as being independent may form a portion of another component, and/or one or more of the component described as forming a portion of another component may be independent.

It should be understood that the term “contact center system” is used herein to refer to the system depicted in FIG. 1 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 100), the associated customer service provider (such as a particular customer service provider/agent providing customer services through the contact center system 100), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals,” “customers,” or “contact center clients”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots,” automated chat modules or “chatbots,” and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 100 may be used by a customer service provider to provide various types of services to customers. For example, the contact center system 100 may be used to engage and manage interactions in which automated processes (or bots) or human agents communicate with customers. As should be understood, the contact center system 100 may be an in-house facility to a business or enterprise for performing the functions of sales and customer service relative to products and services available through the enterprise. In another embodiment, the contact center system 100 may be operated by a third-party service provider that contracts to provide services for another organization. Further, the contact center system 100 may be deployed on equipment dedicated to the enterprise or third-party service provider, and/or deployed in a remote computing environment such as, for example, a private or public cloud environment with infrastructure for supporting multiple contact centers for multiple enterprises. The contact center system 100 may include software applications or programs, which may be executed on premises or remotely or some combination thereof. It should further be appreciated that the various components of the contact center system 100 may be distributed across various geographic locations and not necessarily contained in a single location or computing environment.

It should further be understood that, unless otherwise specifically limited, any of the computing elements of the present invention may be implemented in cloud-based or cloud computing environments. As used herein and further described below in reference to the computing device 200, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

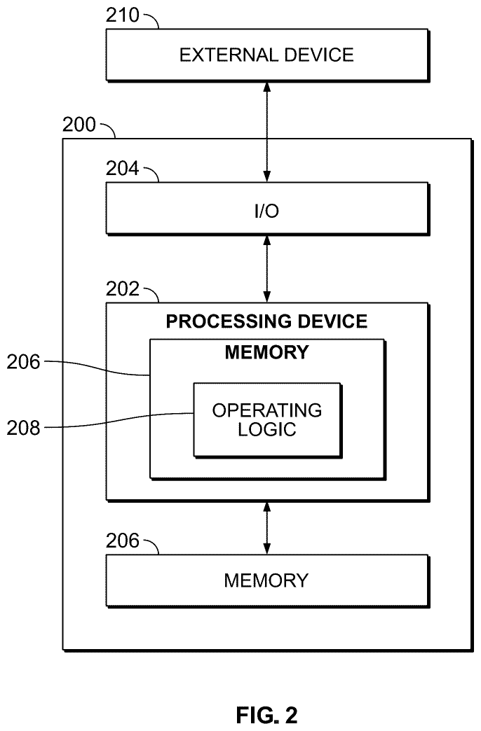

It should be understood that any of the computer-implemented components, modules, or servers described in relation to FIG. 1 may be implemented via one or more types of computing devices, such as, for example, the computing device 200 of FIG. 2. As will be seen, the contact center system 100 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 100 may initiate inbound communications (e.g., telephone calls, emails, chats, etc.) to the contact center system 100 via a customer device 102. While FIG. 1 shows one such customer device—i.e., customer device 102—it should be understood that any number of customer devices 102 may be present. The customer devices 102, for example, may be a communication device, such as a telephone, smart phone, computer, tablet, or laptop. In accordance with functionality described herein, customers may generally use the customer devices 102 to initiate, manage, and conduct communications with the contact center system 100, such as telephone calls, emails, chats, text messages, web-browsing sessions, and other multi-media transactions.

Inbound and outbound communications from and to the customer devices 102 may traverse the network 104, with the nature of the network typically depending on the type of customer device being used and the form of communication. As an example, the network 104 may include a communication network of telephone, cellular, and/or data services. The network 104 may be a private or public switched telephone network (PSTN), local area network (LAN), private wide area network (WAN), and/or public WAN such as the Internet. Further, the network 104 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 106 may be coupled to the network 104 for receiving and transmitting telephone calls between customers and the contact center system 100. The switch/media gateway 106 may include a telephone or communication switch configured to function as a central switch for agent level routing within the center. The switch may be a hardware switching system or implemented via software. For example, the switch 106 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 118. Thus, in general, the switch/media gateway 106 establishes a voice connection between the customer and the agent by establishing a connection between the customer device 102 and agent device 118.

As further shown, the switch/media gateway 106 may be coupled to the call controller 108 which, for example, serves as an adapter or interface between the switch and the other routing, monitoring, and communication-handling components of the contact center system 100. The call controller 108 may be configured to process PSTN calls, VoIP calls, and/or other types of calls. For example, the call controller 108 may include computer-telephone integration (CTI) software for interfacing with the switch/media gateway and other components. The call controller 108 may include a session initiation protocol (SIP) server for processing SIP calls. The call controller 108 may also extract data about an incoming interaction, such as the customer's telephone number, IP address, or email address, and then communicate these with other contact center components in processing the interaction.

The interactive media response (IMR) server 110 may be configured to enable self-help or virtual assistant functionality. Specifically, the IMR server 110 may be similar to an interactive voice response (IVR) server, except that the IMR server 110 is not restricted to voice and may also cover a variety of media channels. In an example illustrating voice, the IMR server 110 may be configured with an IMR script for querying customers on their needs. For example, a contact center for a bank may instruct customers via the IMR script to “press 1” if they wish to retrieve their account balance. Through continued interaction with the IMR server 110, customers may receive service without needing to speak with an agent. The IMR server 110 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment.

The routing server 112 may function to route incoming interactions. For example, once it is determined that an inbound communication should be handled by a human agent, functionality within the routing server 112 may select the most appropriate agent and route the communication thereto. This agent selection may be based on which available agent is best suited for handling the communication. More specifically, the selection of appropriate agent may be based on a routing strategy or algorithm that is implemented by the routing server 112. In doing this, the routing server 112 may query data that is relevant to the incoming interaction, for example, data relating to the particular customer, available agents, and the type of interaction, which, as described herein, may be stored in particular databases. Once the agent is selected, the routing server 112 may interact with the call controller 108 to route (i.e., connect) the incoming interaction to the corresponding agent device 118. As part of this connection, information about the customer may be provided to the selected agent via their agent device 118. This information is intended to enhance the service the agent is able to provide to the customer.

It should be appreciated that the contact center system 100 may include one or more mass storage devices-represented generally by the storage device 114—for storing data in one or more databases relevant to the functioning of the contact center. For example, the storage device 114 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 114 may store agent data in an agent database. Agent data maintained by the contact center system 100 may include, for example, agent availability and agent profiles, schedules, skills, handle time, and/or other relevant data. As another example, the storage device 114 may store interaction data in an interaction database. Interaction data may include, for example, data relating to numerous past interactions between customers and contact centers. More generally, it should be understood that, unless otherwise specified, the storage device 114 may be configured to include databases and/or store data related to any of the types of information described herein, with those databases and/or data being accessible to the other modules or servers of the contact center system 100 in ways that facilitate the functionality described herein. For example, the servers or modules of the contact center system 100 may query such databases to retrieve data stored therein or transmit data thereto for storage. The storage device 114, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 116 may be configured to record and aggregate data relating to the performance and operational aspects of the contact center system 100. Such information may be compiled by the statistics server 116 and made available to other servers and modules, such as the reporting server 134, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 118 of the contact center system 100 may be communication devices configured to interact with the various components and modules of the contact center system 100 in ways that facilitate functionality described herein. An agent device 118, for example, may include a telephone adapted for regular telephone calls or VoIP calls. An agent device 118 may further include a computing device configured to communicate with the servers of the contact center system 100, perform data processing associated with operations, and interface with customers via voice, chat, email, and other multimedia communication mechanisms according to functionality described herein. Although FIG. 1 shows three such agent devices 118—i.e., agent devices 118A, 118B and 118C—it should be understood that any number of agent devices 118 may be present in a particular embodiment.

The multimedia/social media server 120 may be configured to facilitate media interactions (other than voice) with the customer devices 102 and/or the servers 128. Such media interactions may be related, for example, to email, voice mail, chat, video, text-messaging, web, social media, co-browsing, etc. The multimedia/social media server 120 may take the form of any IP router conventional in the art with specialized hardware and software for receiving, processing, and forwarding multi-media events and communications.

The knowledge management server 122 may be configured to facilitate interactions between customers and the knowledge system 124. In general, the knowledge system 124 may be a computer system capable of receiving questions or queries and providing answers in response. The knowledge system 124 may be included as part of the contact center system 100 or operated remotely by a third party. The knowledge system 124 may include an artificially intelligent computer system capable of answering questions posed in natural language by retrieving information from information sources such as encyclopedias, dictionaries, newswire articles, literary works, or other documents submitted to the knowledge system 124 as reference materials. As an example, the knowledge system 124 may be embodied as IBM Watson or a similar system.

The chat server 126, it may be configured to conduct, orchestrate, and manage electronic chat communications with customers. In general, the chat server 126 is configured to implement and maintain chat conversations and generate chat transcripts. Such chat communications may be conducted by the chat server 126 in such a way that a customer communicates with automated chatbots, human agents, or both. In exemplary embodiments, the chat server 126 may perform as a chat orchestration server that dispatches chat conversations among the chatbots and available human agents. In such cases, the processing logic of the chat server 126 may be rules driven so to leverage an intelligent workload distribution among available chat resources. The chat server 126 further may implement, manage, and facilitate user interfaces (UIs) associated with the chat feature, including those UIs generated at either the customer device 102 or the agent device 118. The chat server 126 may be configured to transfer chats within a single chat session with a particular customer between automated and human sources such that, for example, a chat session transfers from a chatbot to a human agent or from a human agent to a chatbot. The chat server 126 may also be coupled to the knowledge management server 122 and the knowledge systems 124 for receiving suggestions and answers to queries posed by customers during a chat so that, for example, links to relevant articles can be provided.

The web servers 128 may be included to provide site hosts for a variety of social interaction sites to which customers subscribe, such as Facebook, Twitter, Instagram, etc. Though depicted as part of the contact center system 100, it should be understood that the web servers 128 may be provided by third parties and/or maintained remotely. The web servers 128 may also provide webpages for the enterprise or organization being supported by the contact center system 100. For example, customers may browse the webpages and receive information about the products and services of a particular enterprise. Within such enterprise webpages, mechanisms may be provided for initiating an interaction with the contact center system 100, for example, via web chat, voice, or email. An example of such a mechanism is a widget, which can be deployed on the webpages or websites hosted on the web servers 128. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 130 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 130 may be configured to interact with the routing server 112 for selecting an appropriate agent to handle each of the deferrable activities. Once assigned to a particular agent, the deferrable activity is pushed to that agent so that it appears on the agent device 118 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 118 may include a workbin. As an example, a workbin may be maintained in the buffer memory of the corresponding agent device 118.

The universal contact server (UCS) 132 may be configured to retrieve information stored in the customer database and/or transmit information thereto for storage therein. For example, the UCS 132 may be utilized as part of the chat feature to facilitate maintaining a history on how chats with a particular customer were handled, which then may be used as a reference for how future chats should be handled. More generally, the UCS 132 may be configured to facilitate maintaining a history of customer preferences, such as preferred media channels and best times to contact. To do this, the UCS 132 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 134 may be configured to generate reports from data compiled and aggregated by the statistics server 116 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 136 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), screen recording, speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 138 may be configured to provide systems and methods for performing analytics on data received from a plurality of different data sources as functionality described herein may require. In accordance with example embodiments, the analytics module 138 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 138 may have access to the data stored in the storage device 114, including the customer database and agent database. The analytics module 138 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 138 may be configured to retrieve data stored within the storage device 114 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 138 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 138 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 1 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact center system 100 may be affected through user interfaces (UIs) which may be generated on the customer devices 102 and/or the agent devices 118.

As noted above, in some embodiments, the contact center system 100 may operate as a hybrid system in which some or all components are hosted remotely, such as in a cloud-based or cloud computing environment. It should be appreciated that each of the devices of the contact center system 100 may be embodied as, include, or form a portion of one or more computing devices similar to the computing device 200 described below in reference to FIG. 2.

Referring now to FIG. 2, a simplified block diagram of at least one embodiment of a computing device 200 is shown. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein—such as the contact center system 100 of FIG. 1—the various servers and computer devices thereof may be located on local computing devices 200 (e.g., on-site at the same physical location as the agents of the contact center), remote computing devices 200 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, Fire Wire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

As described above, contact centers often suffer from high turnover, which is problematic because hiring and training new agents to fill vacant positions is costly and time consuming. Providing agents with tools to control their schedules can be an effective way to improve agent motivation and reduce turnover. Shift bidding is a process that can provide agents with more control over their schedules. With shift bidding, the computing system generates a list of shifts and allows the agents to bid on their preferred shifts. After the agents bid on them, shifts are assigned to the agents based on the agent shift rankings and/or other criteria such as agent performance and/or agent seniority. Because the shifts that the agents can bid on are already generated, there is no risk that the assignments would negatively impact service level (i.e., the shift times are already predefined). Instead of shift bidding, the technologies described herein leverage work plan bidding, which is similar in concept but fundamentally different in its technical implementation as described herein.

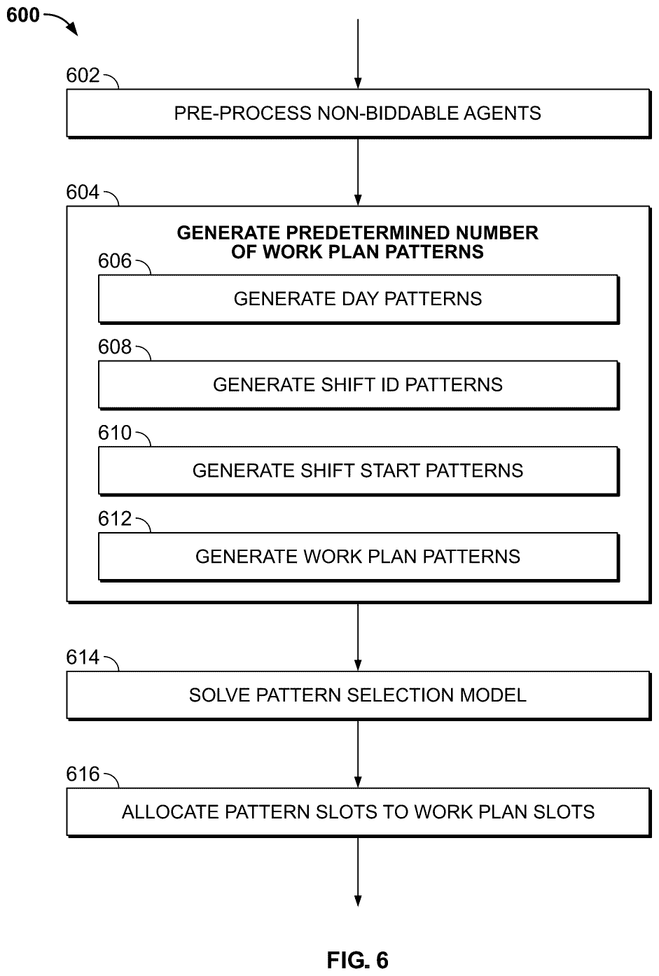

Work plan bidding may be considered a three-step problem. First, the optimal number of each work plan to offer may be calculated, second, the agents may provide their preferences as to which work plans they would prefer, and third, the agents are assigned to work plans based on their preferences and/or other criteria (e.g., agent seniority, agent performance criteria, etc.). Determining the optimal number of slots to offer is a complex problem that includes contact forecasting and modeling and involves determining how much staffing is required to hit service level commitments. Then, the work plan constraints and capabilities of each agent are considered to project the coverage of the forecast requirements. To determine the optimal number of slots, the slot optimization process described in reference to the method 600 of FIG. 6 may be executed. Further, contact center administrators may override the suggestions of the slot optimization process to adjust the agent assignments (e.g., based on upcoming promotions, minimum/maximum number of seats, etc.).

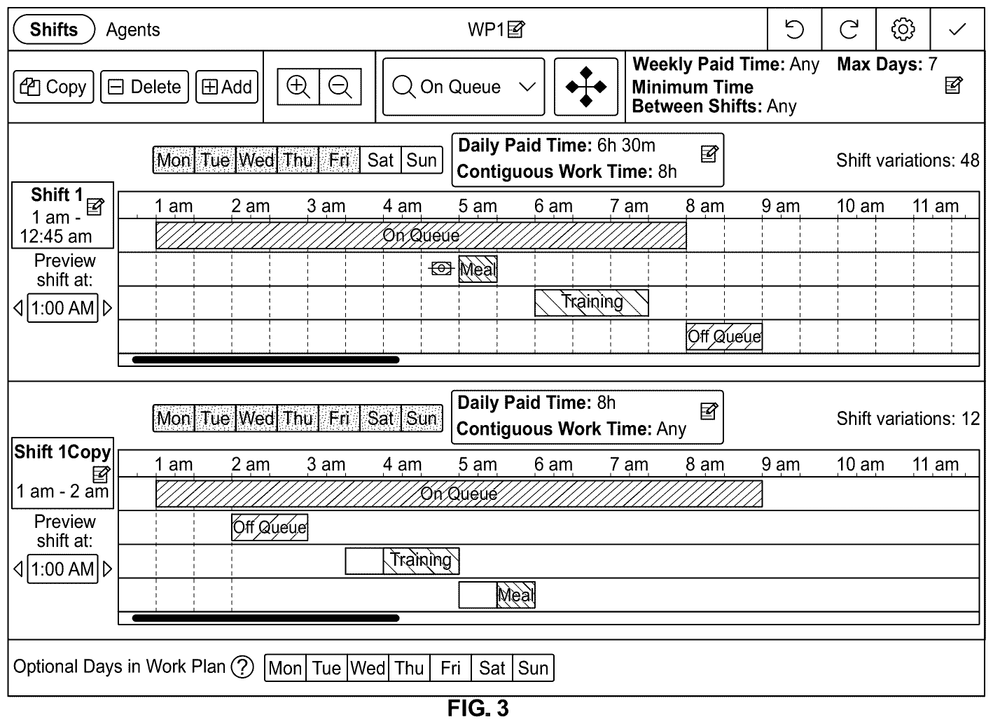

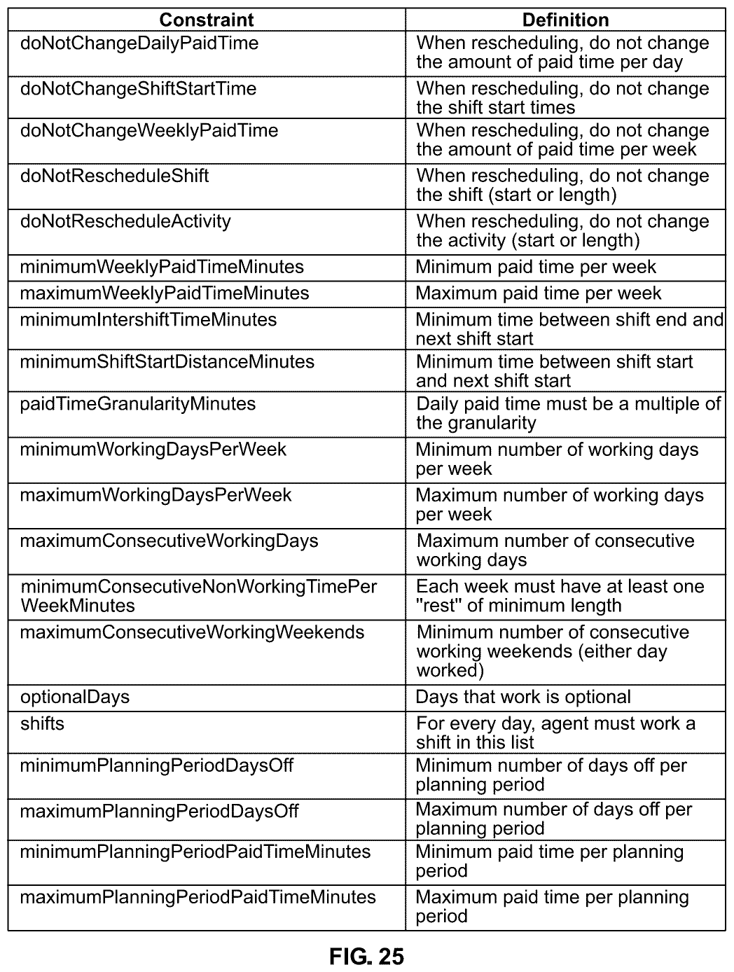

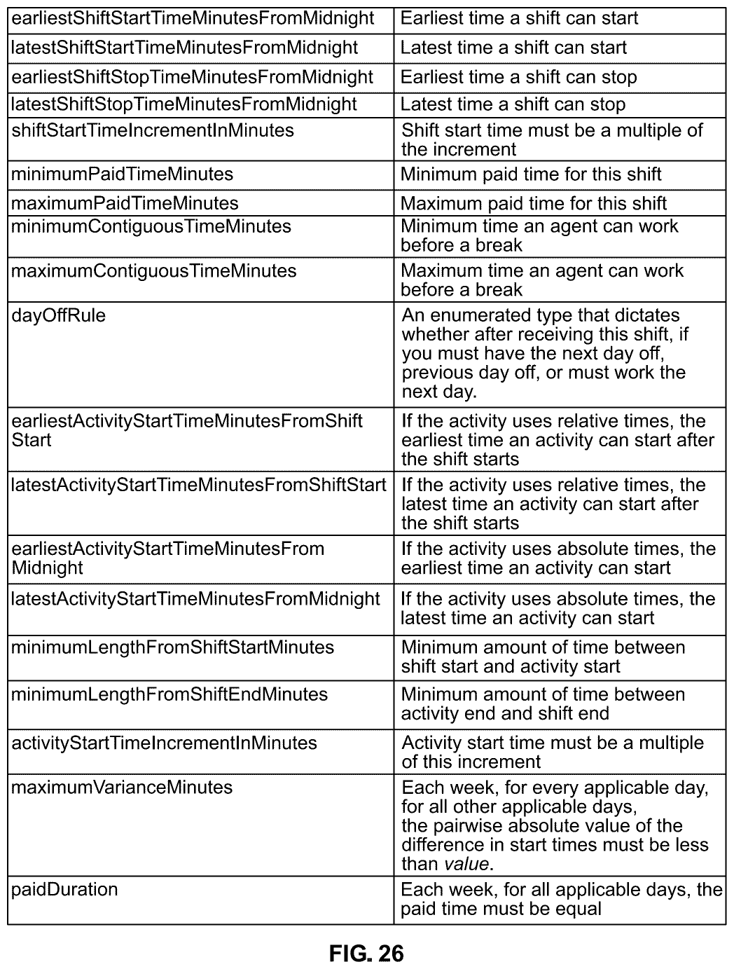

Agent schedules may be generated based on a work plan, which is a set of working constraints. As such, all schedules generated from a work plan must meet all of the constraints of that work plan. The constraints in a work plan may include required work days of the week, optional work days of the week, weekly minimum paid time, weekly maximum paid time, minimum work days per week, maximum work days per week, and/or other constraints. Additionally, different types of shifts may be configured for certain days of the week, each with its own constraints (e.g., activities such as breaks and meals, earliest start time, earliest end time, latest start time, latest end time, daily paid times, etc.). An example work plan is illustrated in FIG. 3. As shown, the exemplary work plan includes two types of shifts, with no constraints on weekly paid time, seven maximum working days, and no minimum time required between shifts. FIGS. 25-26 illustrate a table that includes a set of example constraints which may be used in a work plan, along with the definitions of those constraints.

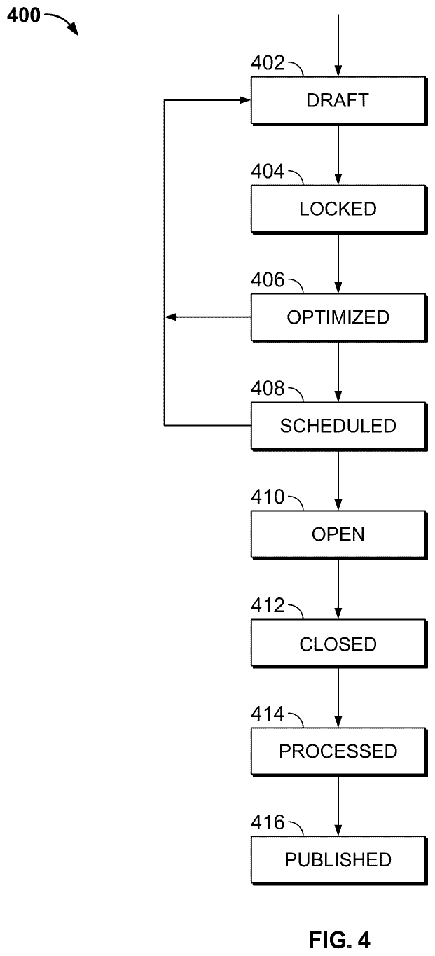

A work plan bid is the process of configuration, slot optimization, agent voting/requesting, and work plan assignment. In some embodiments, it should be appreciated that the work plan bid may employ a finite state machine, such as the finite state machine 400 of FIG. 4 to proceed through the various states in processing a work plan bid. As shown in FIG. 4, the illustrative finite state machine 400 includes a draft state 402, a locked state 404, an optimized state 406, a scheduled state 408, an open state 410, a closed state 412, a processed state 414, and a published state 416. Is should be appreciated that the state names of the finite state machine 400 are for reference only and not intended to limit the functionality of the respective states. An overview of the work plan bid is depicted by the graphical user interface of FIG. 7.

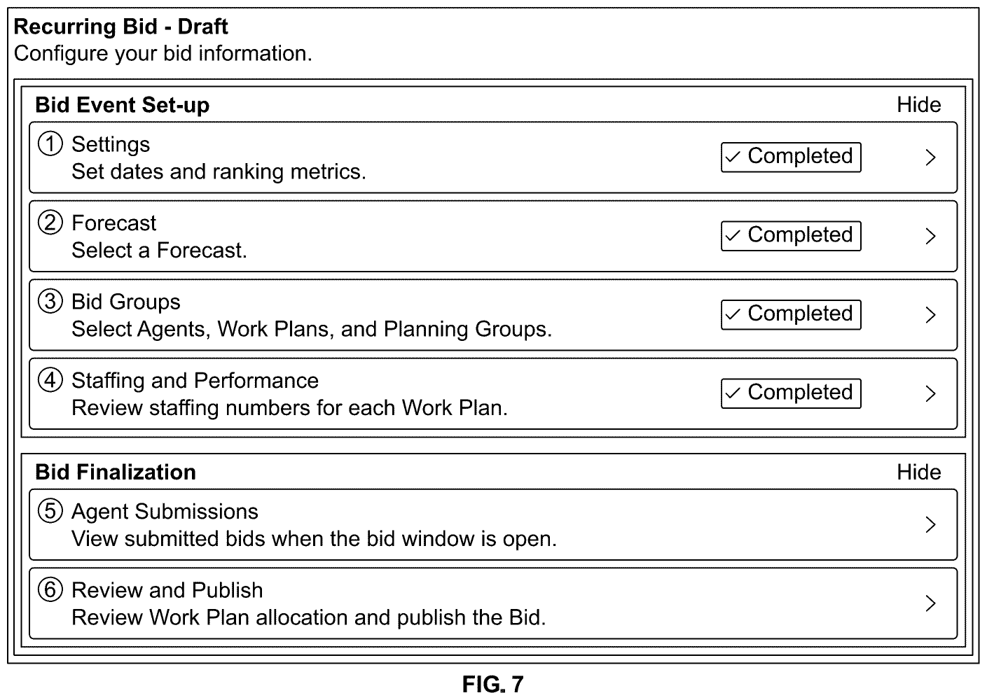

In the draft state 402, the initial setup is performed by an administrative user. For example, the administrative user may configure the agent bid groups, select forecast data as representative data, and/or perform other setup/configuration for the work plan bid. In some embodiments, an agent bid group may have three configurations: a set of agents in a single management unit, a representative skill set that all agents in this bid group share, and a list of work plans on which these agents can bid on. Accordingly, it should be appreciated that each agent bid group may define a distinct group of agents for bidding purposes (e.g., grouped based on such common characteristics). FIG. 8 illustrates an example graphical user interface for configuring bid settings (e.g., as part of the initial setup by the administrator). As shown, the administrative user may provide information related to the bid name (e.g., a string character that names the bid for future reference to the administrative user), indications of which data is visible to the agents (e.g., work plan name, minimum/maximum paid hours that make up a work plan's paid hours, etc.), a bid window (e.g., a section of two date input fields that defines when the bidding phase opens and closes for agents to enter/rank their work plan preferences), an effective date for when agent work plan changes take effect, decision metrics to be used for agent ranking (e.g., whether to prioritize agents having the same work plan preference based on hire date, agent performance, and/or other criteria), decision metrics to be used for agent ranking tie breakers (e.g., based on random selection, agent performance, and/or other criteria), and/or other setup/configuration data for the work plan bid.

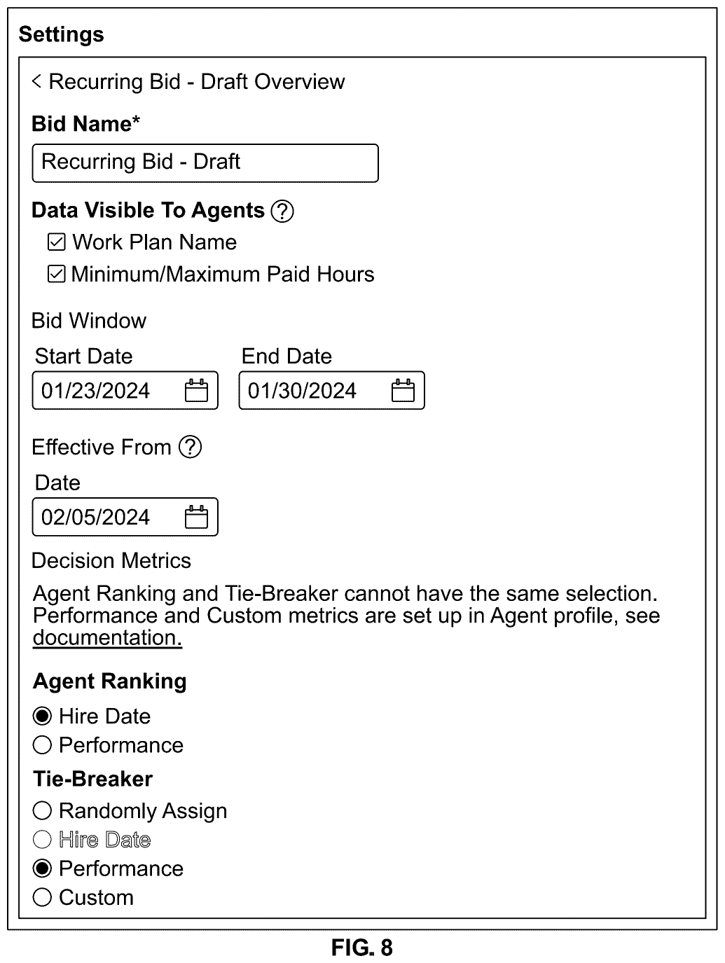

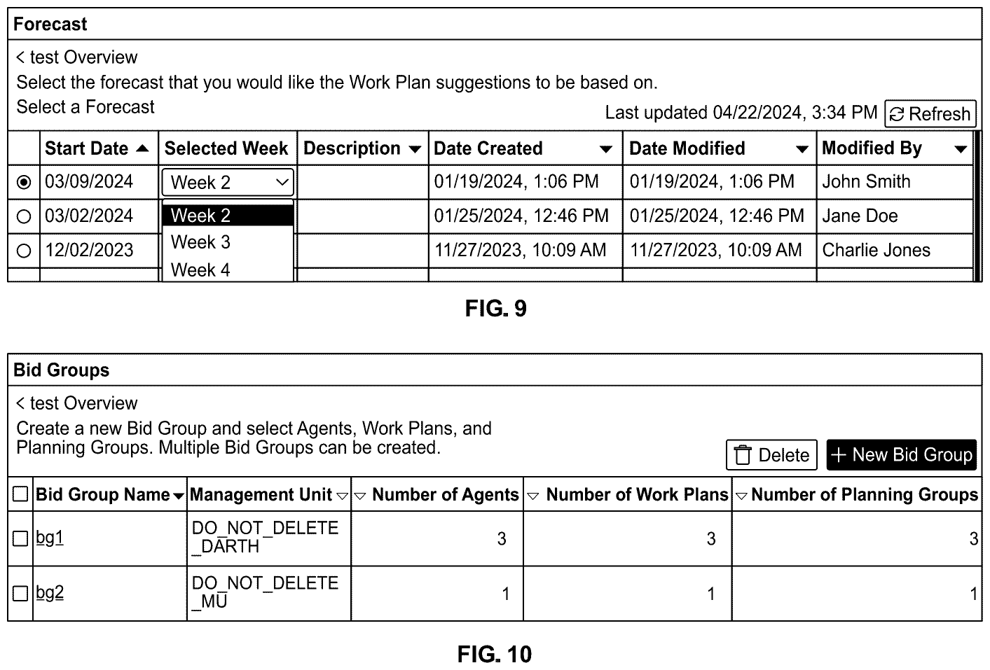

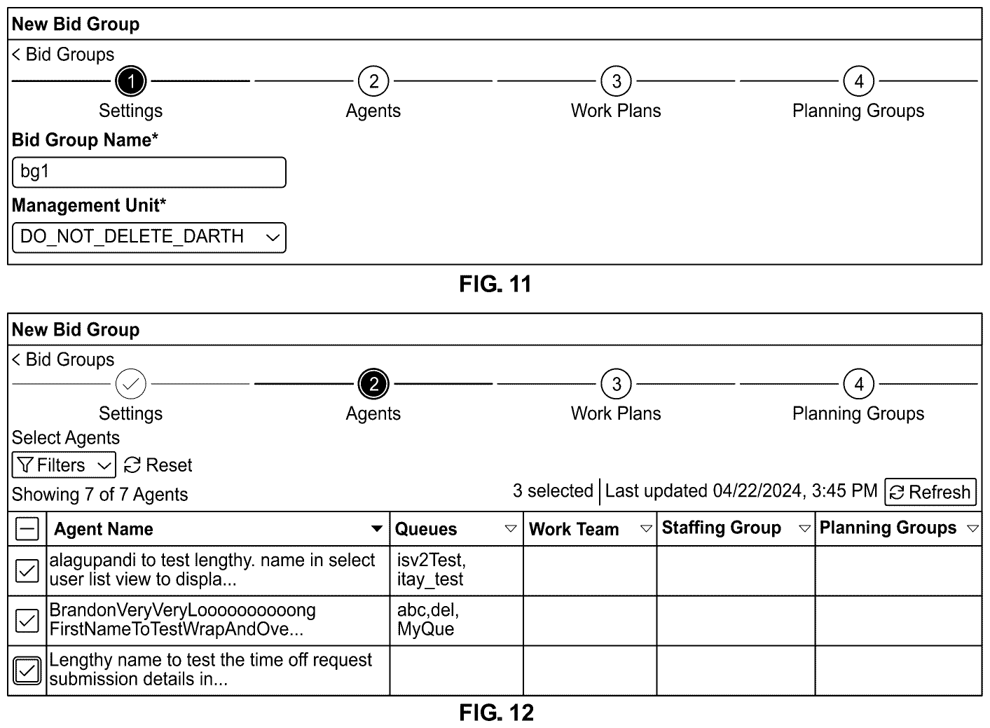

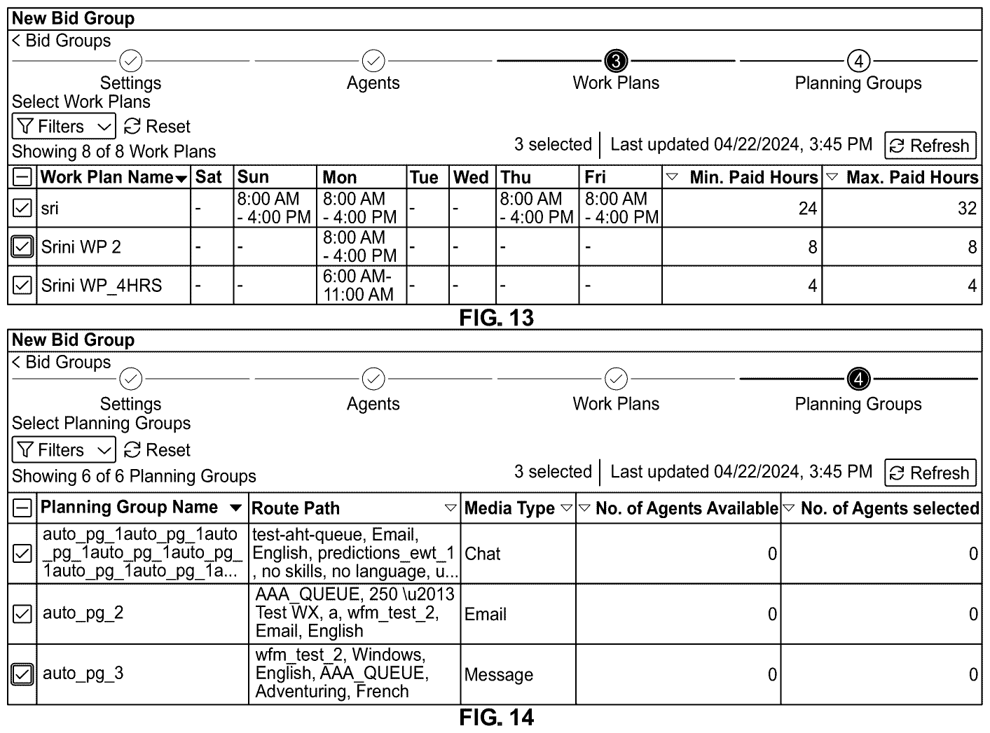

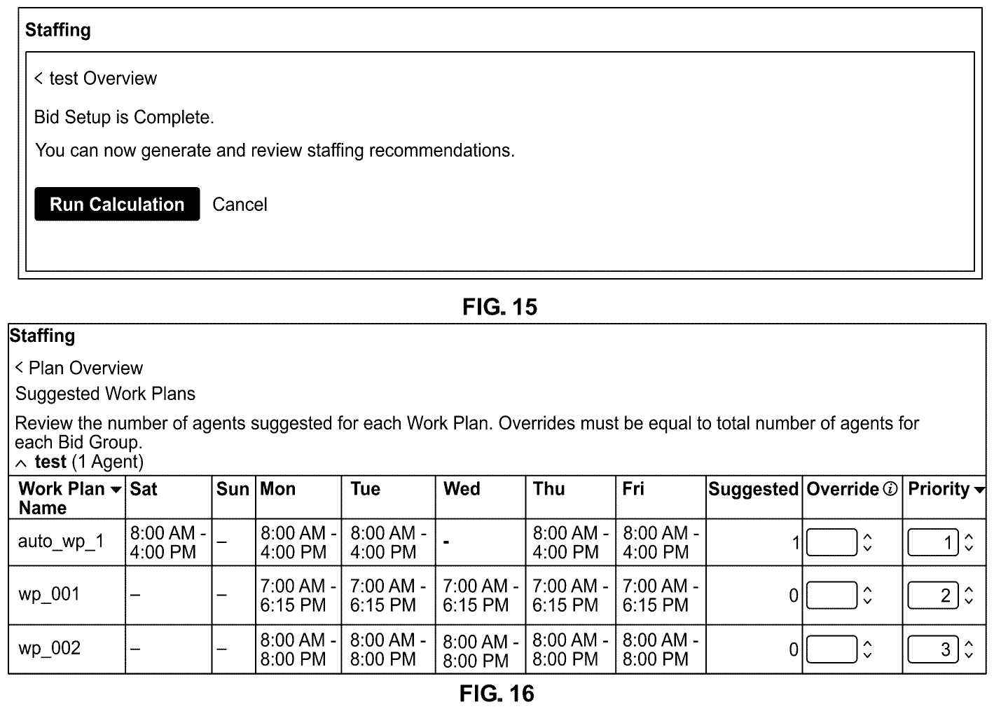

As shown in FIG. 9, the administrative user may select forecast data that is representative of a typical week for the bid period, which may be used by the slot optimization algorithm. As described herein, the agent bid groups may be determined based on data provided by the administrative user. For example, in some embodiments, a graphical user interface may be designed to assist administrative users in associating a single management unit, agents, work plans, and planning groups to a work plan bid. In some embodiments, there may be a maximum number of bid groups (e.g., fifty bid groups), and multiple bid groups may be set up to associate multiple management units, agent groups, or work plan groupings. As shown by the bid groups list of FIG. 10, the administrative user can create, edit, and/or delete big groups and select agents, work plans, and planning groups (or number of agents, work plans, and planning groups) associated with each of the bid groups. FIG. 11 illustrates a graphical user interface through which the administrative user may select a bid group name and management unit configuration. FIG. 12 illustrates a graphical user interface through which the administrative user may select agents to be associated with the selected bid group. FIG. 13 illustrates a graphical user interface for bid group work plan selection, and FIG. 14 illustrates a graphical user interface for bid group planning group association. It should be appreciated that, in some embodiments, planning groups may combine one or more queues, languages, and/or skillsets for scheduling purposes and/or may be associated with a particular media type. After the bid groups have been determined, the slot optimization process may be performed. For example, in some embodiments, the administrative user may utilize the “run calculation” graphical element of the graphical user interface of FIG. 15 to execute a slot optimization algorithm.

In the locked state 404, the slot optimization process is executed to determine suggested slots for agent assignment. In some embodiments, to do so, the slot optimization process described in reference to the method 600 of FIG. 6 may be executed.

In the optimized state 406, the administrator reviews the slots suggested by virtue of the slot optimization process and determines whether to make any changes. For example, the administrative user may change the bid window start/end, effective date, and/or override slot suggestions. In some embodiments, the administrative user may change data from the forecast selection and/or bid group configuration, in which case the new data may be saved, and the finite state machine 400 may return to the draft state 402. As shown in FIG. 16, a graphical user interface may permit an administrative user to view the work plan results after the slot optimization has occurred and, if desired, override various options (e.g., the number of slots for each work plan that agents can bid on).

In the scheduled state 408, the setup is complete and waiting for the agent voting/ranking window to start, so that the agents can rank (e.g., prioritize requests for) the various work plans. In some embodiments, the administrative user may change data similar to the changes described in reference to the optimized state 406.

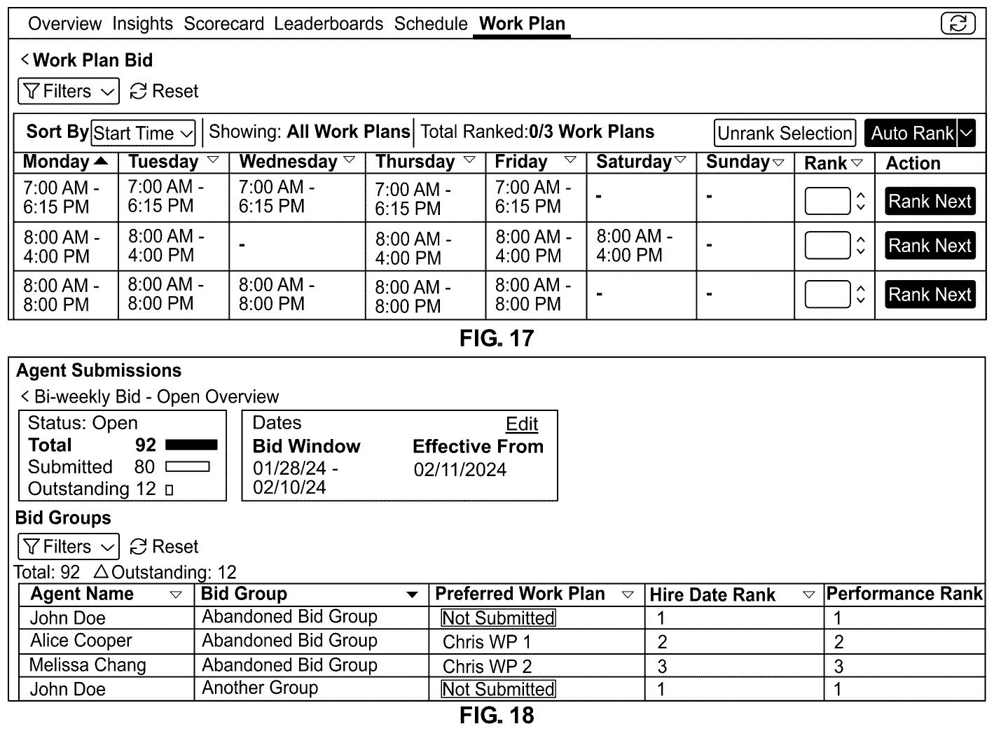

In the open state 410, the agent voting/ranking window is open, and therefore the agents can rank (e.g., prioritize requests for) the various work plans. For example, as shown in FIG. 17, a graphical user interface may allow agents to rank the work plans in their bid group that they would prefer to work (e.g., with a rank of “1” being the most preferred). In some embodiments, a compute ranking without ties must be submitted. In some embodiments, if an agent is indifferent regarding one or more of the work plans, the agent may opt to “auto rank” those work plans, and the computing system may assign a distinct random number (e.g., higher than the ranks that have already been entered) to each of the unranked work plans. Additionally, if an agent does not submit preferences before the bid window closes, the agent may forfeit his or her ranking, and may be assigned work plans after assignments have been made to rank-participating agents. As depicted in FIG. 18, the administrative user may monitor the agent selections as the agents submit their rankings.

In the closed state 412, the agent voting/ranking window is closed, and the agents can no longer rank the work plans. The agents may be preliminarily assigned work plans based on the agent rankings. As described above, the agents may be prioritized based, for example, on agent seniority, performance characteristics, and/or other relevant criteria. In particular, in some embodiments, once the bidding window is close and all agents have either submitted their designed work plan preferences/rankings or abstained from ranking them, the system may assign agents to work plans according to a predefined order. That is, the system may find the highest-ranking agent (based on the configured decision metrics) not yet assigned to a work plan, assign that agent to the agent's most preferred work plan that still has slots available (and mark one of those slots as used), and repeat this process until all agents have been assigned preliminary/tentative work plans.

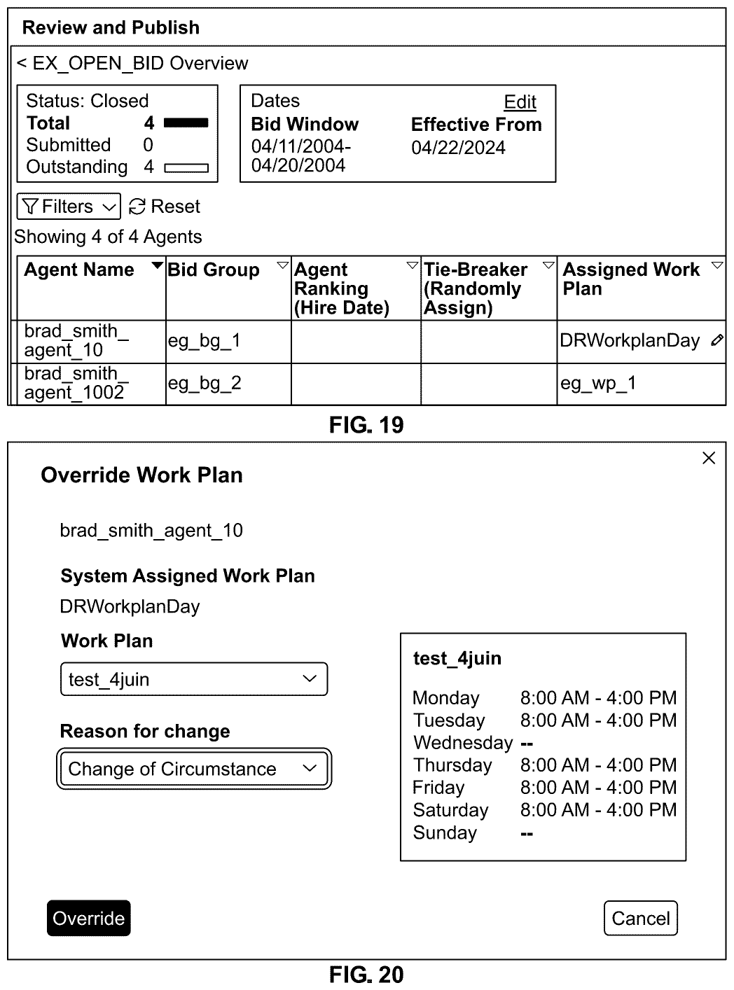

In the processed state 414, the work plan assignments may be reviewed and evaluated by the administrative user. In some embodiments, the administrative user may manually change one or more of the agent assignments and/or other characteristics of the work plan assignments. FIG. 19 illustrates a graphical user interface through which an administrative user may review the assignment results, and FIG. 20 illustrates a graphical user interface through which the administrative user can override an agent work plan assignment.

In the published state 416, the work plan bid is finalized and published to the agents and/or other entities. The agents may begin their assigned work plan on the effective data defined by the published work plan bid.

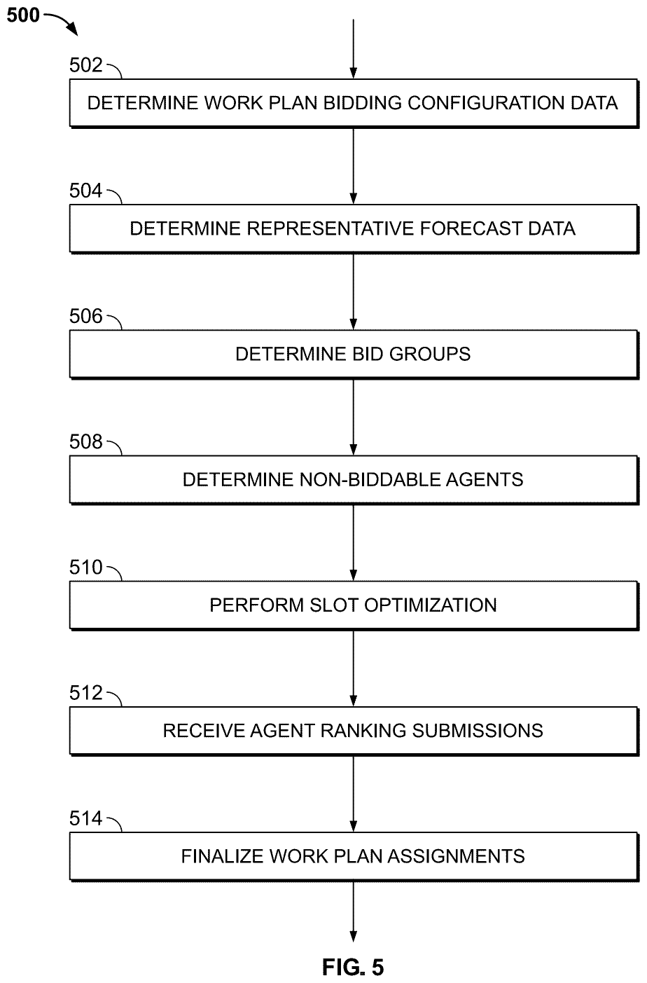

Referring now specifically to FIG. 5, in use, a computing system (e.g., the contact center system 100, the computing device 200, and/or other computing devices described herein) may execute a method 500 for determining work plan assignments in contact centers. It should be appreciated that the particular blocks of the method 500 are illustrated by way of example, and such blocks may be combined or divided, added or removed, and/or reordered in whole or in part depending on the particular embodiment, unless stated to the contrary.

The illustrative method 500 begins with block 502 in which the computing system determines work plan bidding configuration data. For example, in some embodiments, the computing system may determine the work plan name, minimum/maximum paid hours that make up a work plan's paid hours, bid window, effective data, decision metrics for agent ranking, and/or other setup/configuration data for the work plan bid. FIG. 8 illustrates an exemplary graphical user interface for configuring bid settings.

In block 504, the computing system determines forecast data that is representative of a typical week for the bid period. It should be appreciated that the “normalcy” of a typical week may change relatively frequently, and therefore what constitutes a “typical” week may change over time. FIG. 9 illustrates an exemplary graphical user interface for administrative user selection of forecast data.

In block 506, the computing system determines bid groups. As described herein, an agent bid group may have three configurations: a set of agents in a single management unit, a representative skill set that all agents in this bid group share, and a list of work plans on which these agents can bid on. It should be appreciated that the agents belonging to the respective agent bid groups may be administratively selected (see, for example, FIGS. 10-14) or automatically determined based on one or more criteria (e.g., common skillset, common management unit, etc.).

In block 508, the computing system determines non-biddable agents. That is, it should be appreciated that a contact center may staff one or more “non-biddable” agents who are not intended to participate in a work plan bidding process. For example, the non-biddable agents may have predefined work schedules and/or otherwise predefined work plans, and therefore those agents may be scheduled as normal without participation in the work plan ranking scheme.

In block 510, the computing system performs slot optimization. To do so, in some embodiments, the computing system may execute the method 600 of FIG. 6 described below.

In block 512, the computing system receives agent ranking submissions from the agents and, in block 514, the computing system finalizes work plan assignments. For example, as described above, the administrative user may accept the agent work plan assignments tentatively made by the slot optimization and/or override one or more of the agent assignments before finalizing the agent work plan assignments. It should be appreciated that, in some embodiments, the computing system may automatically transmit a respective work schedule to each of the agents and/or provide a notification that the agent work plan assignments have been finalized and are available for access.

Although the blocks 502-514 are described in a relatively serial manner, it should be appreciated that various blocks of the method 500 may be performed in parallel in some embodiments.

Referring now specifically to FIG. 6, in use, a computing system (e.g., the contact center system 100, the computing device 200, and/or other computing devices described herein) may execute a method 600 for optimizing slot allocations for work plan assignments in contact centers. It should be appreciated that the particular blocks of the method 600 are illustrated by way of example, and such blocks may be combined or divided, added or removed, and/or reordered in whole or in part depending on the particular embodiment, unless stated to the contrary.

As described above, work plans are a set of constraints from which shifts can be chosen. One of the unique challenges of work plan bidding is technical and computational difficulty of estimating the service level impact of assigning agents to work plans. Such estimation is technically complex, because the impact on service level of an agent working with a particular work plan depends on the shifts that will eventually be generated from it, not from the work plan itself. The slot optimization process involves determining how many of each work plan should be offered to each bid group, which provides the contact center organization with confidence that the resulting assignment of agents to work plans will achieve the respective service level goals.

Given a set of staffing requirements (e.g., based on representative forecast data) and a work plan bid, the slot optimization problem involves finding a number of agents that can be assigned to each work plan to optimize service level (e.g., to minimize understaffing/overstaffing). The slot optimization technologies described herein solves two main challenges: the work plan's contribution to service level and how much understaffing/overstaffing they produce and the associated scalability. As described herein, the slot optimization utilizes the concept of a work plan pattern, which is a set of shifts that meet all work plan constraints. Because a work plan pattern has specific shifts, that information can be used to determine the work plan pattern's contribution toward the service level criteria. Given the potential of as many as 27 decillion potential “weeks” of shifts, the slot optimization technologies described here leverages various constraints in order to perform slot optimization at scale.

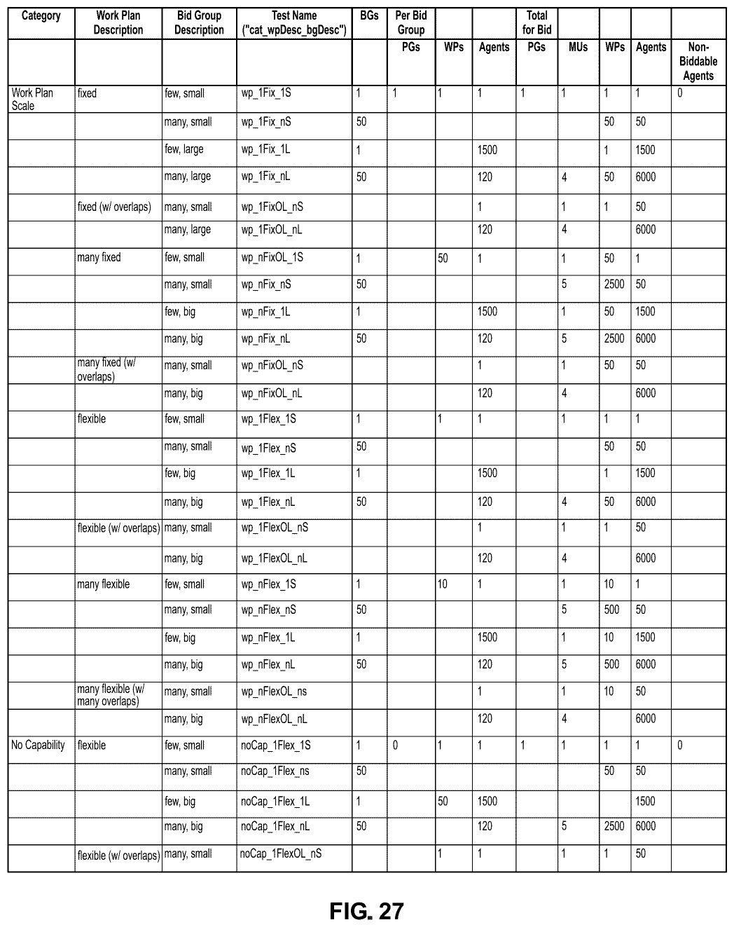

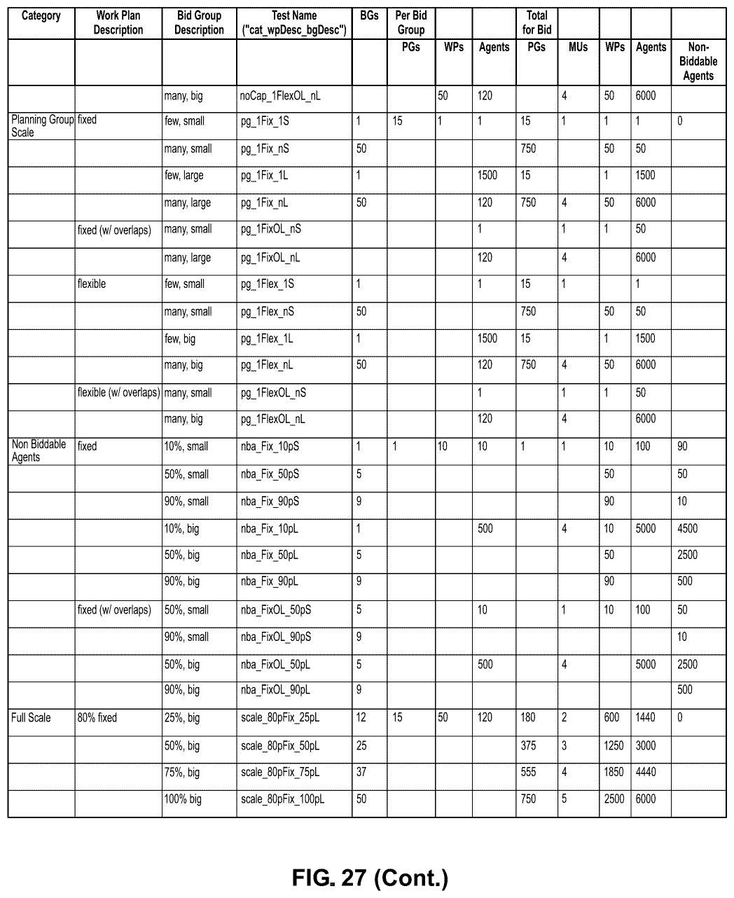

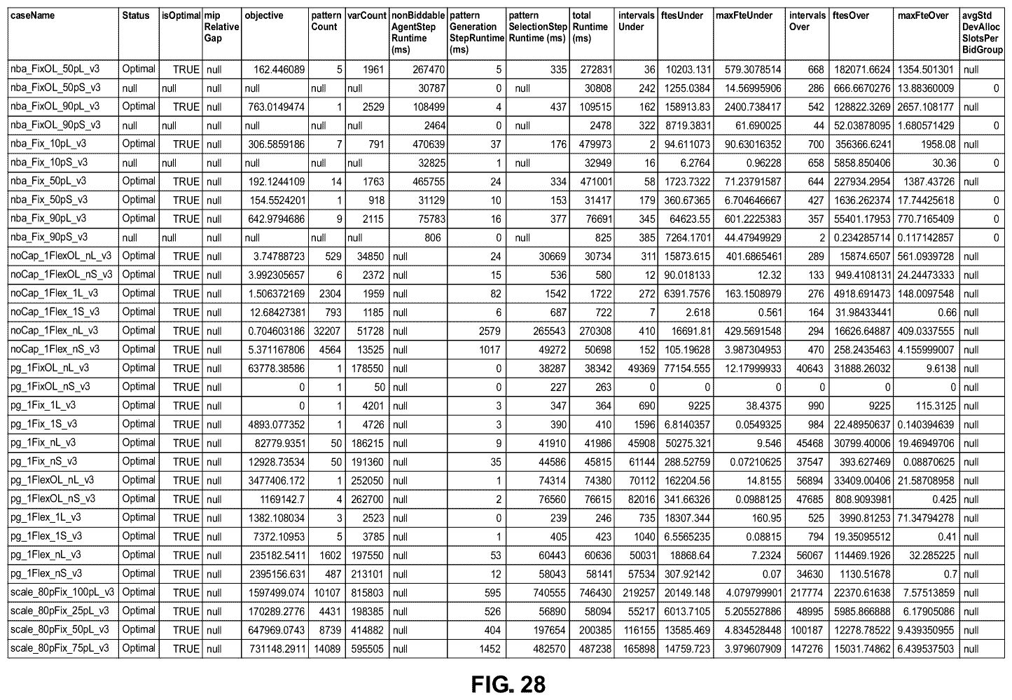

It should be appreciated that the slot optimization may leverage various limits. For example, in some embodiments, the computing system may have limits for the number of bid groups per bid (e.g., 50), the number of distinct agents (e.g., 6,000) per bid, the number of planning groups in the representative forecast per bid (e.g., 1,000), the number of planning groups in representative capability per bid group (e.g., 15), the number of work plans per bid group (e.g., 50), the number of agents per bid group (e.g., 1,500), and/or other limits. FIG. 27 includes a table of slot allocation benchmarks for various types of work plans, and FIG. 28 provides the results for each of the slot allocation benchmarks. As reflected by the benchmark results, even with significant limitations on the scope of the slot optimization problem, the runtime for most optimizations is not negligible.

The illustrative method 600 begins with block 602 in which the computing system pre-processed non-biddable agents. As described above, “non-biddable” agents are those agents who are not intended to participate in a work plan bidding process. For example, the non-biddable agents may have predefined work schedules and/or otherwise predefined work plans, and therefore those agents may be scheduled as normal without participation in the work plan ranking scheme. However, because these non-biddable agents contribute to the service level, they must be considered in the slot optimization. Therefore, schedules are generated for each of the non-biddable agents (e.g., based on their predefined arrangements), the contributions of those schedules to the staffing requirements are calculated, and the forecast staffing requirement is adjusted based on those contributions. It should be appreciated that the adjusted forecast staffing requirements are used for the subsequent steps in slot optimization. Additionally, the agent assignments for those non-biddable agents are saved for output validation data.

In block 604, the computing system generates a predetermined number of work plan patterns for each work plan. In order to do so, in the illustrative embodiment, the computing system generates various different patterns. More specifically, in block 606, the computing system generates day patterns. In the illustrative embodiment, a day pattern indicates the working days and days off for a week. In block 608, the computing system generates shift identifier (ID) patterns based on the day patterns. In the illustrative embodiment, a shift ID pattern indicates a shift ID for each working day in a week. In block 610, the computing system generates shift start patterns based on the shift ID patterns. In the illustrative embodiment, a shift start pattern indicates a shift's start time and a shift's end time (e.g., from midnight) for each shift ID in the work plan. In block 612, the computing system generates work plan patterns based on the shift start patterns. In the illustrative embodiment, a work plan pattern indicates a shift start pattern assigned to each day of the week.

In the illustrative embodiment, the computing system leverages a tiered list data structure to implement the patterns described herein. However, it should be appreciated that the patterns may be otherwise implemented in other embodiments. A tiered list may have certain characteristics. For example, the items in the tiered list may be “bucketed” into tiers so that a list of patterns in a specific tier may be retrieved. The tiers may be ordered with a comparator, and iterating the list may return items in tier order. Further, the tiered lists can be “fanned out” into other tiered lists. For example, one pattern of Type A can be used to generate patterns of Type B. In some embodiments, the “fanning out” of tiered lists may be capped at a predefined N number of total elements, such that the last “fan out” that would cause an overflow is randomly sampled to get exactly N elements.

As indicated above, in some embodiments, the work plan patterns of a work plan may be generated by first generating day patterns, which may be stored in a tiered list. Then, shift ID patterns may be generated by “fanning out” the day patterns tiered list to a shift ID patterns tiered list. Then, the shift start patterns may be generated and stored in a tiered list. Then the work plan patterns may be generated by executing a breadth-first search over the shift ID tiered list and the start pattern tiered list. After a work plan pattern has been defined, the computing system can estimate the on-queue times, which are the times of the day when an agent assigned to the work plan pattern can handle the workload and estimate its contribution to the service level.

In the illustrative embodiment, the day patterns leveraged by the computing system may be represented as a 7-bit unsigned binary number (i.e., 0-127), and the bits are set on workings days. The tiering for the day patterns may be by contiguous working days (circular) in ascending order, and there may be an assumption that workers would rather work most of their days in one chunk and have a long “weekend” (i.e., the more consecutive days off, the better). The constraints enforced may include required days (e.g., days in shifts not marked optional in the work plan), days off (e.g., days not in any shift), minimum working days per week, maximum working days per week, and weekly long rest (e.g., in number of days, rounded down). The day patterns may be generated using bit math. In particular, bit masks may be created for required days and for days off. The bit mask for required days may have 1s on required days, and bitwise ANDing (&) a day pattern with the work plan's required days mask yields the mask (i.e., all required days in the pattern are also 1). The bit mask for days off may have Is on the days off, and bitwise ANDing (&) a day pattern with the day's mask yields 0 (i.e., none of the days off in the pattern are also 1). The computing system may iterate through the patterns and evaluate those patterns against the constraints. More specifically the computing system may iterate for patterns between having the minimum working days at the end of the week up to having the maximum working days at the start of the week, check these patterns against the bit masks, confirm that the number of bits set is within the working days per week (i.e., within the minimum and maximum working days per week thresholds), and confirm that there is a sequence of zeroes long enough for the required weekly long rest.

In the illustrative embodiment, the shift ID patterns leveraged by the computing system may be represented as an array of shift IDs for each day in the week (e.g., with −1 for a day off). The tiering for the shift ID patterns may be by distinct shift ID count, then by number of day-to-day shift ID transitions, and there may be an assumption that workers would rather work fewer types of shifts and, if they must witch shift types, they would prefer to do so as few times as possible. The constraints enforced may include minimum weekly paid time, maximum weekly paid time, inter-shift time (e.g., the distance between the previous shift's end time and the next shift's start time), and shift start distance (e.g., the distance between the start time of two consecutive shifts). The shift ID patterns may be generated using recursion. More specifically, for each day pattern, the computing system may use recursion to apply all shift IDs for each working day. The outputs are then filtered for eligibility, making sure that the pattern of shift IDs still meet weekly paid time, inter-shift time, and shift start distance constraints.

In the illustrative embodiment, the shift start patterns leveraged by the computing system may be represented as feasible tuples (e.g., <start, length>) for a shift (e.g., relative to midnight), whereby the length is the total shift length (e.g., not just the paid time). The tiering for the shift start patterns may be by the absolute difference from median paid time, then by start granularity (e.g., hourly, half-hourly, quarter-hourly, 5-minute, then 1-minute), and there may be assumption that workers want most of their shifts to be the same length and to start on a larger granularity that is easier for planning purposes. The constraints enforced may include the earliest start time, latest start time, minimum (paid) length, maximum (paid) length, and start time increment. The shift start patterns may be generated by iterating combinations of shift starts. More specifically, shift start patterns for each shift in a work plan may be generated by iterating all combinations of shift starts, stepping by the increment, and paid lengths. The fixed unpaid time from activities may be added to each pattern. Then, all of the shift patterns from each shift in the work plan may be combined into a single tiered list based on their ordinal tiering in their respective shift. For example, if Shift #1 has <8:00a, 8h>in the top tier and Shift #2's has <8:05a, 7:30h>in the top tier, then Shift #1's pattern is an objectively “better” tier. However, they may both be placed into the top tier of the work plan, because they are the best those respective shifts can offer.

In the illustrative embodiment, the work plan patterns leveraged by the computing system may be represented as an array of shift start patterns for each day of the week (e.g., with null for days off). The constraints enforced may include the minimum weekly paid time, maximum weekly paid time, inter-shift time (e.g., distance between the previous shift's end time and the next shift's start time), and shift start distance (e.g., distance between the start time of two consecutive shifts). The work plan patterns may be generated by combining a shift ID pattern with several shift start patterns. In particular, the computing system may use a breadth-first search to iterate the two tiered lists for tuples of tiers (aka “tier nodes”), trying new shift ID tiers before new shift start tiers, which allows for more diverse weeks. The computing system then retrieves all patterns for the tier for each tier node. For every shift ID pattern, the computing system adds the unique IDs into a queue and double recurses. The computing system pops a unique ID from the queue and, for each shift start pattern of that ID, clones the work plan pattern(s) and substitutes the shift start pattern for each instance of the shift ID in the pattern. If exploring a node would result in exceeding the maximum number of patterns to generate, the computing system may use the same random sampling to the tiered list fan out. The computing system may first try to use the same <start, length> tuple for each time that a shift appears in a week based on the observation that two patterns are symmetric (i.e., can provide the same coverage). For example, Agent A working at 8 am on Monday and 9 am on Tuesday and Agent B working at 9 am on Monday and 8 am on Tuesday is symmetric to Agent A working 8 am on Monday and 8 am on Tuesday and Agent B working at 9 am on Monday and 9 am on Tuesday. Because the computing system's focus is coverage, there is no need to have two work plan patterns with the same coverage and, therefore, the computing system may only keep one such pattern in some embodiments. If the symmetry assumption does not yield sufficient work plan patterns, the computing system may “fall back” by re-tiering the shift start patterns only by granularity, which may ensure that all lengths appear in each tier. Then, the computing system may again try the work plan pattern generated described above, but without the symmetry assumption (e.g., trying each shift start pattern for each day).

In some embodiments, the computing system may take each work plan pattern and convert it to a vector of 1s where that pattern is on-queue and 0s otherwise for every 15 minutes (or other predefined period). In some embodiments, in the work plan pattern, the computing system does not consider specific activity start and end times because of scalability issues. More specifically, the activity patterns would substantially increase the scale of the problem, and activities are typically a small part of a shift (e.g., 11% for a 9 hr shift involving 30 min meal and two 15 min breaks), so they would not change the coverage significantly. Accordingly, the computing system may incorporate the reduction in coverage caused by activities (i.e., agents do not handle workload during activities) by averaging them out over the start times and deduct that on-queue time, which provides more flexibility to hand the uncertain forecast. For example, suppose a 15-minute break could start between 1 pm and 3 pm. Assuming 15-minute intervals, then 1 interval out of the 8 intervals between those times will not be on-queue. Because the particular interval within the 8 intervals is unknown, the computing system can deduct ⅛ (or 0.125) from each interval to account for it. With the coverage pattern for each work plan generated, the computing system may tag the coverage patterns with the work plan they were generated from, as the same patterns may be generated from different work plans. Unique pattern IDs may be assigned, and the computing system may go through each bid group to provide it with a random sampling of candidate patterns among its work plans.

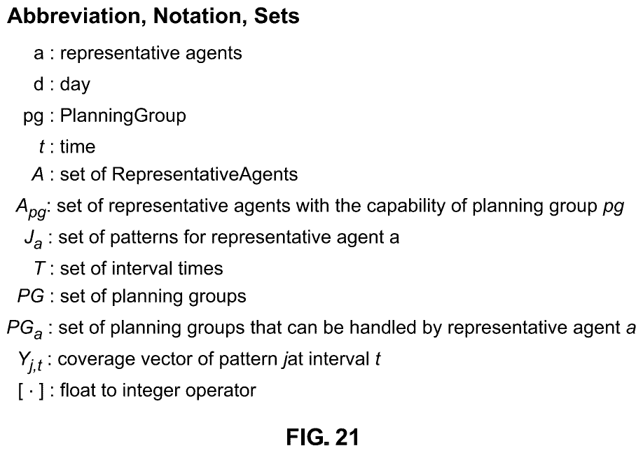

In block 614, the computing system solves a pattern selection model to determine, for example, which work plan patterns each bid group should use and how many should be used. In particular, the computing system may first solve for the bid groups with no feasible patterns and/or those not configured to do any work (i.e., not contributing to the service level). For the bid groups that do not affect service level, the agents in these bid groups may be assigned to the work plan they prefer. Thus, the computing system may evenly distribute the available slots among all bid group work plans, so that all work plans are available to be chosen. For the bid groups that do contribute to service level, the computing system may solve a linear program whose components are described by the pattern selection model of FIGS. 21-23.

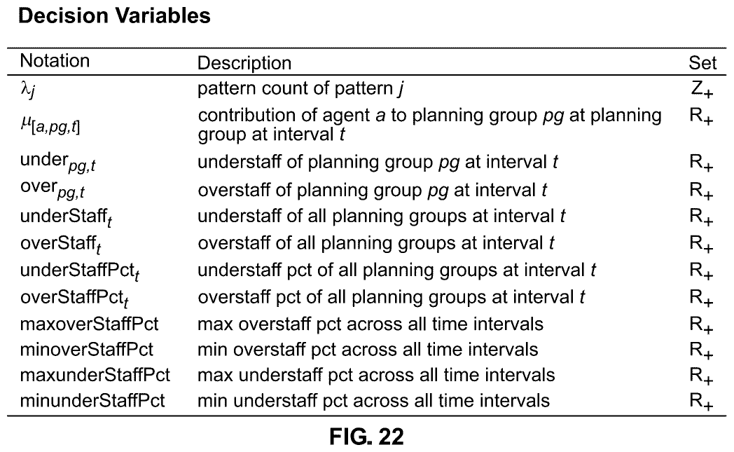

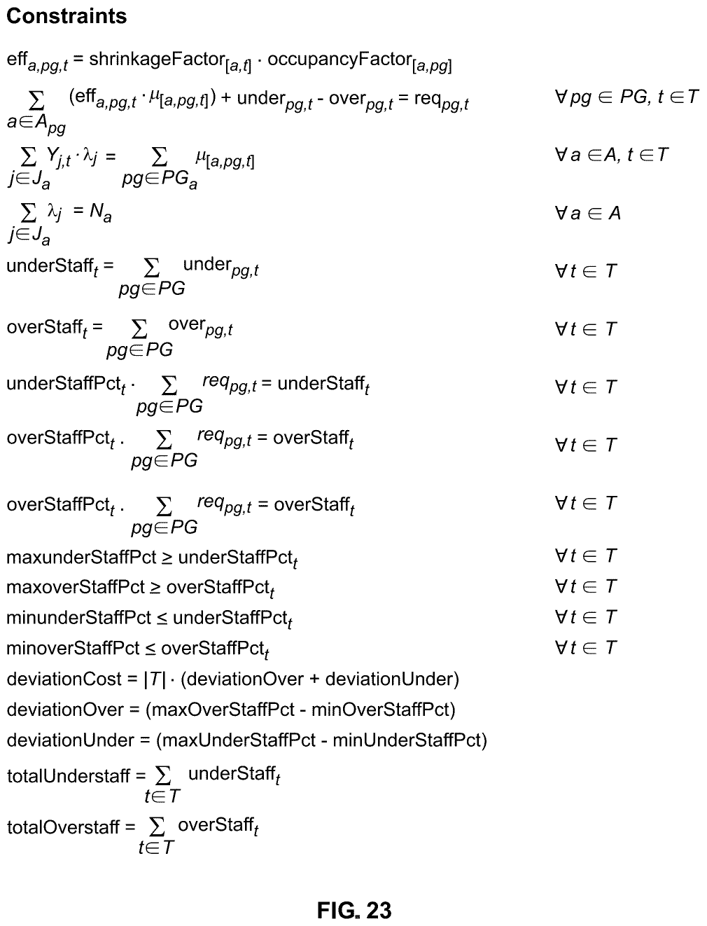

In particular, the pattern selection model leveraged by the computing system may include as inputs the capabilities of the agents, the number of slots to be assigned and work plan patterns for each bid group, the workload (staffing requirements) for each planning group, and the management unit settings. Additionally, using the abbreviations, notations, and sets defined in FIG. 21, it should be appreciated that the pattern selection model may include the decision variables of FIG. 22 and the constraints of FIG. 23. The constraints may include that all bid group available time must be assigned to planning groups (e.g., otherwise, understaffing or overstaffing may occur), the number of slots assigned to work plan patterns in a bid group must be equal to the number of agents in that bid group, and/or expressions for calculating the total understaff, total overstaff, understaff percentages, overstaff percentages, overstaff deviations, and/or understaff deviations. The objective function leveraged by the model, for example, to minimize understaffing, overstaffing, and the deviations therefrom may be expressed according to deviationCost+totalUnderStaff+totalOverStaff.

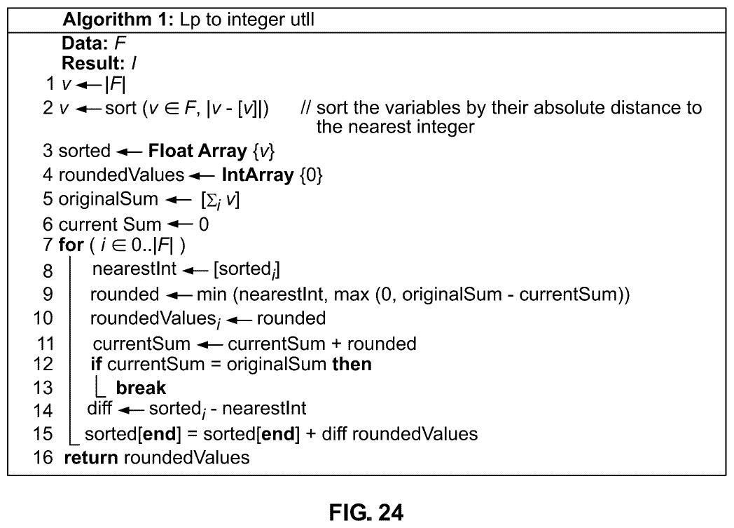

It should be appreciated that, in the illustrative embodiment, the number of patterns assigned to each work plan must be an integer value. Although an integer value may be determined by solving a mixed-integer linear program (MILP), the computational complexity and therefore solution time could be relatively long. Accordingly, in the illustrative embodiment, the computing system may leverage a linear program and solve for a floating-point number of patterns to be selected per bid group. In some embodiments, the algorithm of FIG. 24 may be executed to iteratively round the floating-point number variables to the nearest integer. It should be appreciated that alternative algorithms for converting the floating-point number outputted by the linear program to integers in other embodiments.

In block 616, the computing system allocates work plan slots based on the solved pattern selection model, for example, by defining a number of agents that can be assigned to each work plan. In other words, after the computing system has calculated the number of slots that should be assigned to each pattern, the computing system determined the number of slots to assign to each work plan. In some embodiments, to do so, the computing system may execute a greedy heuristic and solve for each bid group. To improve runtime, in some embodiments, the heuristic for each bid group (or multiple of the bid groups) may be executed in parallel. In some embodiments, the heuristic may include four steps. First, the computing system allocates slots from patterns that could have only come from a single work plan. Second, the computing system calculates slot ranges for all work plans, and the minimum of which is the result of the first step, and the maximum is if it were allocated every slot from pattern selections that could have originated from that work plan. Third, for the remaining slots, the computing system may sort the remaining patterns from least flexible (i.e., fewest work plans it could be generated from) to most flexible. Four, the computing system retrieves the next selected pattern and, for each full-time equivalent (FTE) assigned to this pattern, the computing system allocates one slot to the work plan that has the fewest slots allocated so far, and repeats until the slots for all patterns have been assigned to work plans. It should be appreciated that execution of the heuristic may result in a fair allocation in which the suggested allocation of slots to work plans is evenly distributed, which allows the bidding agents to have more choices of work plans to bid on and creases the chances of being assigned to the work plan being bid on by the agents.

In the illustrative embodiment, the outputs of the slot optimization includes slot allocations for each bid group and validation for each planning group (e.g., for each 15-minute interval or other predefined interval). The slot allocations for each bid group may include the work plan ID, the suggested slots, and/or the slot range (e.g., if two work plans can produce the same pattern). The validation data may include biddable assignments, biddable headcount multipliers (e.g., forecast shrinkage), non-biddable assignments, and/or non-biddable headcount multipliers (e.g., forecast shrinkage). The validation data may be used to generate biddable scheduled versus adjusted required staff, which may be how the graphical user interface shows the “accuracy” of the bid and if it can be expected to hit the service goals.

Although the blocks 602-616 are described in a relatively serial manner, it should be appreciated that various blocks of the method 600 may be performed in parallel in some embodiments.

What is claimed is:

1. A method of optimizing slot allocations for agent work plan assignments in contact centers, the method comprising:
generating, by a computing system, a predetermined number of work plan patterns;
solving, by the computing system, a pattern selection model based on the generated work plan patterns to determine a type and number of work plan patterns to be used for each agent bid group of a plurality of agent bid groups, wherein the pattern selection model includes a plurality of constraints and at least one objective function, and wherein each agent bid group of the plurality of agent bid groups defines a distinct group of agents; and
allocating, by the computing system, agent work plan slots based on the solved pattern selection model by defining a number of agents that can be assigned to each work plan pattern of the plurality of work plan patterns.

2. The method of claim 1, wherein the at least one objective function is based on an understaffing parameter and an overstaffing parameter.

3. The method of claim 1, wherein the plurality of constraints includes a constraint that all agent bid group available time must be assigned to planning groups.

4. The method of claim 1, wherein the plurality of constraints includes a constraint that a number of slots assigned to the work plan patterns in a particular agent bid group is equal to a number of agents in the particular agent bid group.

5. The method of claim 1, wherein the pattern selection model includes as inputs at least one of capabilities of the agents, a number of slots to be assigned for each agent bid group of the plurality of agent bid groups, work plan patterns for each agent bid group of the plurality of agent bid groups, or a workload for each planning group.

6. The method of claim 1, wherein determining the agent work plan slots comprises executing a greedy heuristic to solve for each agent bid group of the plurality of agent bid groups.

7. The method of claim 1, further comprising pre-processing, by the computing system, non-biddable agents; and
wherein generating the predetermined number of work plan patterns comprises generating the predetermined number of work plan patterns subsequent to pre-processing the non-biddable agents.

8. The method of claim 1, wherein generating the predetermined number of work plan patterns comprises generating a plurality of day patterns, wherein each day pattern of the plurality of day patterns is indicative of a unique set of working days and days off for a week.

9. The method of claim 8, wherein generating the predetermined number of work plan patterns comprises generating a plurality of shift identifier (ID) patterns based on the plurality of day patterns, wherein each shift ID pattern of the plurality of shift ID patterns is indicative of a shift ID for each working day in a week.

10. The method of claim 9, wherein generating the predetermined number of work plan patterns comprises generating a plurality of shift start patterns based on the plurality of shift ID patterns, wherein each shift start pattern of the plurality of shift start patterns is indicative of a shift start time and a shift end time for each shift ID in the work plan.

11. The method of claim 10, wherein generating the predetermined number of work plan patterns comprises generating a plurality of work plan patterns based on the plurality of shift start patterns, wherein each work plan pattern of the plurality of work plan patterns is indicative of a shift start pattern assigned to each day of the week.

12. The method of claim 1, wherein generating the predetermined number of work plan patterns comprises utilizing a first tiered list data structure for storing data associated with the plurality of day patterns, a second tiered list data structure for storing data associated with the plurality of shift ID patterns, and a third tiered list data structure for storing data associated with the plurality of shift start patterns.

13. The method of claim 1, further comprising determining, by the computing system, forecast data representative of a typical week at a contact center; and
wherein generating the predetermined number of work plan patterns comprises generating the predetermined number of work plan patterns based on the forecast data.

14. The method of claim 1, wherein solving the pattern selection model based on the generated work plan patterns comprises solving a linear program.

15. A computing system for optimizing slot allocations for agent work plan assignments in contact centers, the system comprising:
at least one processor; and
at least one memory comprising a plurality of instructions stored thereon that, in response to execution by the at least one processor, causes the computing system to:
generate a predetermined number of work plan patterns;
solve a pattern selection model based on the generated work plan patterns to determine a type and number of work plan patterns to be used for each agent bid group of a plurality of agent bid groups, wherein the pattern selection model includes a plurality of constraints and at least one objective function, and wherein each agent bid group of the plurality of agent bid groups defines a distinct group of agents; and
allocate agent work plan slots based on the solved pattern selection model by defining a number of agents that can be assigned to each work plan pattern of the plurality of work plan patterns.

16. The computing system of claim 15, wherein to generate the predetermined number of work plan patterns comprises to generate a plurality of day patterns, wherein each day pattern of the plurality of day patterns is indicative of a unique set of working days and days off for a week.

17. The computing system of claim 16, wherein to generate the predetermined number of work plan patterns comprises to generate a plurality of shift identifier (ID) patterns based on the plurality of day patterns, wherein each shift ID pattern of the plurality of shift ID patterns is indicative of a shift ID for each working day in a week.

18. The computing system of claim 17, wherein to generate the predetermined number of work plan patterns comprises to generate a plurality of shift start patterns based on the plurality of shift ID patterns, wherein each shift start pattern of the plurality of shift start patterns is indicative of a shift start time and a shift end time for each shift ID in the work plan.

19. The computing system of claim 18, wherein to generate the predetermined number of work plan patterns comprises to generate a plurality of work plan patterns based on the plurality of shift start patterns, wherein each work plan pattern of the plurality of work plan patterns is indicative of a shift start pattern assigned to each day of the week.

20. The computing system of claim 15, wherein to generate the predetermined number of work plan patterns comprises to utilize a first tiered list data structure for storing data associated with the plurality of day patterns, a second tiered list data structure for storing data associated with the plurality of shift ID patterns, and a third tiered list data structure for storing data associated with the plurality of shift start patterns.
